(19) United States
(12) Patent Application Publication
(10) Pub. No.: US 2019/0355039 A1
(43) Pub. Date: Nov. 21, 2019

(54) METHODS OF MANAGING AND QUERYING PRODUCT INVENTORY DATA AND INVENTORY MANAGEMENT SERVER

(71) Applicant: Industrial Technology Research Institute, Hsinchu (TW)

(72) Inventors: Yau-Tai Tzeng, Hsinchu (TW); Yin-Chen Chen, Hsinchu (TW)

(21) Appl. No.: 16/117,244

(22) Filed: Aug. 30, 2018

(30) Foreign Application Priority Data
May 21, 2018 (TW) 107117290

(51) Int. Cl. G06Q 30/06; G06Q 10/08; G06K 7/14; G06K 7/10

(52) U.S. Cl. CPC G06Q 30/0625; G06K 7/10722; G06K 7/1413; G06Q 10/087

(57) ABSTRACT

Methods of managing and querying product inventory data and an inventory management server are disclosed. The method is applicable to at least one electronic communication device and a server, wherein each of the at least one electronic communication device comprises a camera. The method of managing product inventory data includes: capturing an image of a product by the camera to obtain product image data; performing image recognition on the product image data to obtain at least one image characteristic and retrieving at least one product information of the respective product based on at least one of the at least one image characteristic; and creating or updating product inventory data for the product in the server based on the at least one product information.

### CROSS REFERENCE TO RELATED APPLICATION

This application is based on, and claims the priority from Taiwan application serial no. 107117290, filed on May 21, 2018, the disclosure of which is hereby incorporated by reference herein in its entity.

### FIELD OF THE DISCLOSURE

The disclosure directed to methods of managing and querying product inventory data and an inventory management server.

### BACKGROUND OF THE DISCLOSURE

At present, the process of creating inventory in a store is complicated. A user must manually enter each product information into each corresponding field, which is both time consuming and laborious. It creates a great burden for those industries where the variety of product items is large and products are updated quickly.

Current systems for managing and querying inventory information are usually provided in the form of point of sale (POS) systems. Therefore, in order to manage inventory information, a merchant must purchase a complete set of equipment, that is, from server to POS terminal, both must be purchased and updated together, so the cost of acquisition or updating is relatively high, which makes it more difficult for small businesses to adopt. In addition, street vendors are unable to install a complete POS system due to site and surrounding constraints. Therefore, street vendors often fail to manage their inventory data accurately.

### SUMMARY OF THE DISCLOSURE

The present disclosure provides methods of managing and querying product inventory data and an inventory management server.

In an exemplary embodiment, a method of managing product inventory data in accordance with the present disclosure is applicable to at least one electronic communication device and a server communicatively connected with the at least one electronic communication device, wherein each of the at least one electronic communication device comprises a camera, the method comprising: capturing, by the camera, an image of a product to obtain product image data; performing image recognition on the product image data to obtain at least one image characteristic and retrieving at least one product information of the product based on at least one of the at least one image characteristic; and creating or updating a product inventory data for the product in the server based on the at least one product information.

In an exemplary embodiment, an inventory management server in accordance with the present disclosure is communicatively connected with at least one electronic communication device, wherein each of the at least one electronic communication device comprises a camera configured for obtaining product image data of a product, the inventory management server comprising: a communication module, configured to exchange data with the at least one electronic communication device and receive the product image data; and an inventory management module, comprising a product information processing unit and an inventory editing unit configured to communicate with the product information processing unit, wherein the product information processing unit is configured to obtain at least one image characteristic based on the product image data and obtain at least one product information of the product based on the at least one image characteristic, wherein the inventory editing unit is configured to create or update a product inventory data of the product based on the at least one product information.

In another exemplary embodiment, a method of querying product inventory in accordance with the present disclosure is applicable to at least one electronic communication device and a server communicatively connected with the at least one electronic communication device, wherein each of the at least one electronic communication device comprises a camera and the server comprises at least one store inventory database, the method comprising: capturing, by the camera, an image of a product to obtain product image data; receiving, by the server, the product image data from the electronic communication device; comparing the product image data received from the electronic communication device with a plurality of product inventory data in the at least one store inventory database to select at least one of the plurality of product inventory data from the at least one store inventory database; and transmitting the product inventory data selected from the at least one store inventory database to the electronic communication device.

In another exemplary embodiment, an inventory management server in accordance with the present disclosure is communicatively connected with at least one electronic communication device communicatively, wherein each electronic communication device comprises a camera configured for capturing an image of a product to obtain product image data, the inventory management server comprising: a communication module, configured to exchange data with the at least one electronic communication device and receive the product image data; and an inventory management module, configured to compare the product image data received from the electronic communication device with a plurality of product inventory data to select at least one of the plurality of product inventory data, wherein the communication module is further configured to transmit the at least one product inventory data selected from the at least one store inventory database to the electronic communication device.

Based on the above, the product inventory data establishing and query methods and an inventory management server proposed by the embodiments of the present disclosure are capable of establishing and inquiring product inventory data based on an acquired product image data of a product, thereby increasing inventory management efficiency and reducing management cost.

The above features and advantages of the present disclosure can be more fully understood by reading the following embodiments in conjunction with the attached drawings.

### BRIEF DESCRIPTION OF THE DRAWINGS

FIG. 1 is a block diagram depicting an electronic communication device, an inventory management server and a cloud recognition system in accordance with an embodiment of the present disclosure.

FIG. 2 is a flowchart illustrating a method of managing product inventory data in accordance with an embodiment of the present disclosure.

FIG. 3 is a flowchart illustrating a method of managing product inventory data in accordance with another embodiment of the present disclosure.

FIG. 4 is a flowchart illustrating a method of managing product inventory data in accordance with another embodiment of the present disclosure.

FIG. 5 is a flowchart illustrating a method of managing product inventory data in accordance with another embodiment of the present disclosure.

FIG. 6 is a flowchart illustrating a method of managing product inventory data in accordance with another embodiment of the present disclosure.

FIG. 7 is a flowchart illustrating a method of managing product inventory data in accordance with another embodiment of the present disclosure.

FIGS. 8A and 8B are flowcharts illustrating a method of managing product inventory data in accordance with another embodiment of the present disclosure.

FIG. 9 is a flowchart illustrating a method of querying product inventory in accordance with an embodiment of the present disclosure.

FIG. 10 is a flowchart illustrating an embodiment of a compare and select process of the method of querying product inventory shown in FIG. 9.

FIG. 11 is a flowchart illustrating another embodiment of a compare and select process of the method of querying product inventory shown in FIG. 9.

FIG. 12 is a flowchart illustrating another embodiment of a compare and select process of the method of querying product inventory shown in FIG. 9.

FIG. 13 is a flowchart illustrating another embodiment of a compare and select process of the method of querying product inventory shown in FIG. 9.

FIG. 14 is a flowchart illustrating another embodiment of a compare and select process of the method of querying product inventory shown in FIG. 9.

### DETAILED DESCRIPTION OF THE EMBODIMENTS

Throughout the descriptions and drawings of this specification, similar or identical numerals are used to refer to similar or the same elements/components/steps. Descriptions on elements/components/steps designated by the same numerals or using the same terms in different embodiments can be interchangeably referred to.

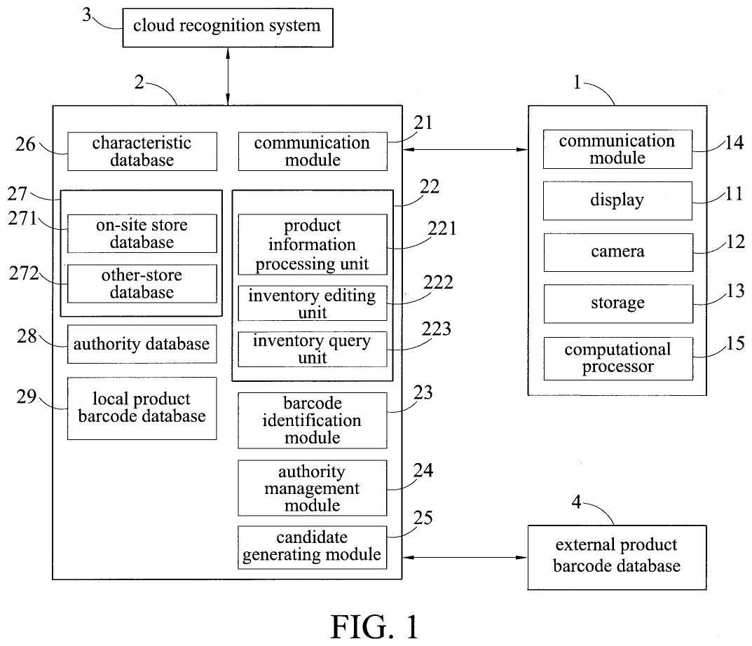

FIG. 1 is a block diagram depicting an electronic communication device 1 and an inventory management server 2 in accordance with an embodiment of the present disclosure. The electronic communication device 1 includes a display 11, a camera 12 for capturing images, a storage 13 for storing data, a communication module 14 for transmitting/receiving data, and a computational processor 15 in signal communication with the display 11, the camera 12, the communication module 14 and the storage 13. The computational processor 15 may perform computations to drive the camera 12 to capture images, drive the communication module 14 to transmit or receive data, and drive the display 11 to display an image. In an embodiment, the electronic communication device 1 is a handheld mobile device, a tablet PC, a notebook computer, a desktop computer, or an intellectual point of sale (iPOS). In another embodiment, the display 11 is a display with a touch screen.

The electronic communication device 1 can be communicatively connected with the inventory management server 2 via the communication module 14. The inventory management server 2 can be communicatively connected to a cloud recognition system 3. The inventory management server 2 includes a communication module 21 for transmitting or receiving data, an inventory management module 22, a barcode identification module 23, an authority management module 24, a candidate generating module 25, a characteristic database 26, and at least one store inventory database 27. The inventory management module 22 includes a product information processing unit 221, an inventory editing unit 222 in signal communication with the product information processing unit 221, and an inventory query unit 223 in signal communication with the product information processing unit 221. The store inventory database 27 stores at least one product inventory data entry. The store inventory database 27 further includes an on-site store database 271 corresponding to the electronic communication device 1 and at least one other-store database 272 not corresponding to the electronic communication device 1. The on-site store database 271 and the other-store database 272 are used for storing product inventory data of their respective stores.

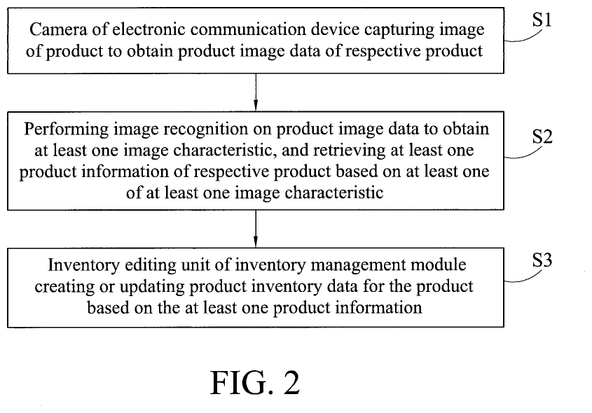

Referring further to FIG. 2, a flowchart illustrating a method of managing product inventory data in accordance with the present disclosure is shown. The method of managing product inventory data allows a merchant to connect to the inventory management server 2 using the electronic communication device 1 for establishing or editing inventory data. The method of managing product inventory data is described below. Step S1 is performed, in which the camera 12 of the electronic communication device 1 captures the image of a product to obtain product image data of the respective product. After product image data is obtained, step S2 is carried out so as to perform image recognition on the product image data to obtain at least one image characteristic, and retrieve at least one product information of the respective product based on at least one of the at least one image characteristic. In step S2, the process of image recognition can be performed by the inventory management server 2 or another cloud service platform. Next, step S3 is performed, in which the inventory editing unit 222 of the inventory management module 22 is configured to create or update a product inventory data for the product based on the at least one product information.

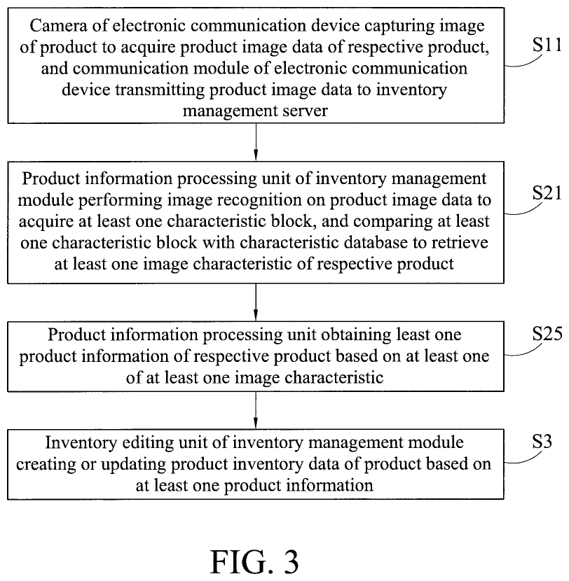

Refer to FIGS. 1 and 3, where FIG. 3 is a flowchart illustrating a method for establishing product inventory data in accordance with another embodiment of the present disclosure. The steps of the method are described as follows. Step S11 is performed, in which the camera 12 of the electronic communication device 1 captures the image of a product to acquire product image data of the respective product, and the communication module 14 of the electronic communication device 1 transmits the product image data to the inventory management server 2.

Once the communication module 21 of the inventory management server 2 has received the product image data, step S21 is performed, in which the product information processing unit 221 of the inventory management module 22 is configured to perform image recognition on the product image data in order to acquire at least one characteristic block. The product information processing unit 221 is further configured to compare the at least one characteristic block with the characteristic database 26 to retrieve at least one image characteristic of the respective product. Then, step S25 is performed, in which at least one product information of the respective product is obtained based on the at least one image characteristic. Thereafter, step S3 is performed, in which the inventory editing unit 222 of the inventory management module 22 is configured to create or update a product inventory data of the product based on the at least one product information. The characteristic block is an image block having a key characteristic, and the image characteristic can be a text description explaining or describing the characteristic block. A cookie product is used as an example for this embodiment. The characteristic block acquired may be an image block containing the logo on the package, a cookie product sketch, or a product description such as text regions of “sandwich cookies,” “cheese flavor,” etc. The image block is compared against data in the characteristic database to obtain an image characteristic, i.e. to obtain the brand name, text descriptions such as “sandwich cookies,” “cheese flavor,” or the like, which is used as the product information of the product.

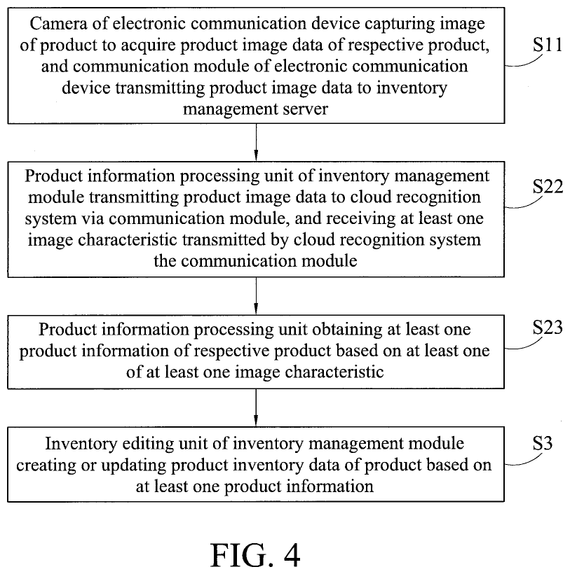

Referring to FIGS. 1 and 4, in another embodiment, after the communication module 21 of the inventory management server 2 receives the product image data, step S22 is performed, in which the product information processing unit 221 of the inventory management module 22 is configured to transmit the product image data to the cloud recognition system 3 via the communication module 21, and receive at least one image characteristic transmitted by the cloud recognition system 3 via the communication module 21. The cloud recognition system 3 in this embodiment performs image recognition based on the product image data received and returns an image recognition result back to the inventory management server 2. The cloud recognition system 3 can be a cloud recognition system with machine learning models and Internet image searching capability, for example, Google Cloud Vision, Microsoft Computer Vision, etc. An application programming interface (API) can be connected with the cloud recognition system to assist in recognition and analysis of the image contents.

After the at least one image characteristic is received, step S23 is performed, in which product information processing unit 221 is configured to obtain at least one product information based on the at least one image characteristic. Then, step S3 is performed, in which the inventory editing unit 222 of the inventory management module 22 is configured to create or update a product inventory data of the product based on the at least one product information.

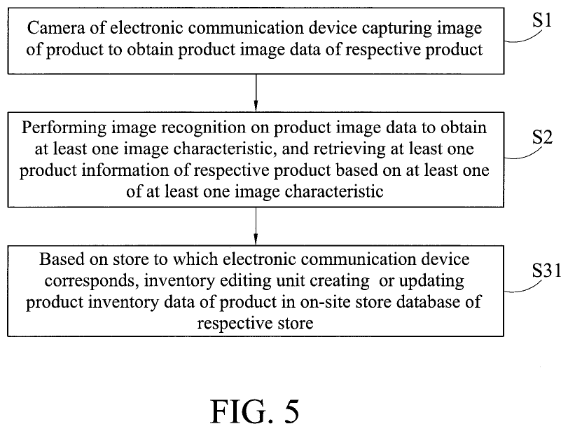

Referring to FIGS. 1 and 5, in another embodiment, after the inventory management server 2 obtains the product information corresponding to the product image information, step S31 is performed, in which based on the store to which the electronic communication device 1 corresponds, the inventory editing unit 222 creates or updates a product inventory data of the product in the on-site store database 271 of the respective store. It should be noted that each product inventory data in the present disclosure includes a plurality of data fields containing information on product characteristics. Items included may be product number, product barcode information, product image, product name, product quantity, product color or type, etc. There may be different items or combinations of items depending on the types of products. As an example, the data fields of food products may include product flavor, storage period, manufacturing date, etc. As another example, the data fields of clothing products may include style, color, size, etc. The purpose of the data fields is to distinguish the differences and features between different products. The merchant can also adjust the items and contents of the data fields according to the specific types and requirements of the merchandise.

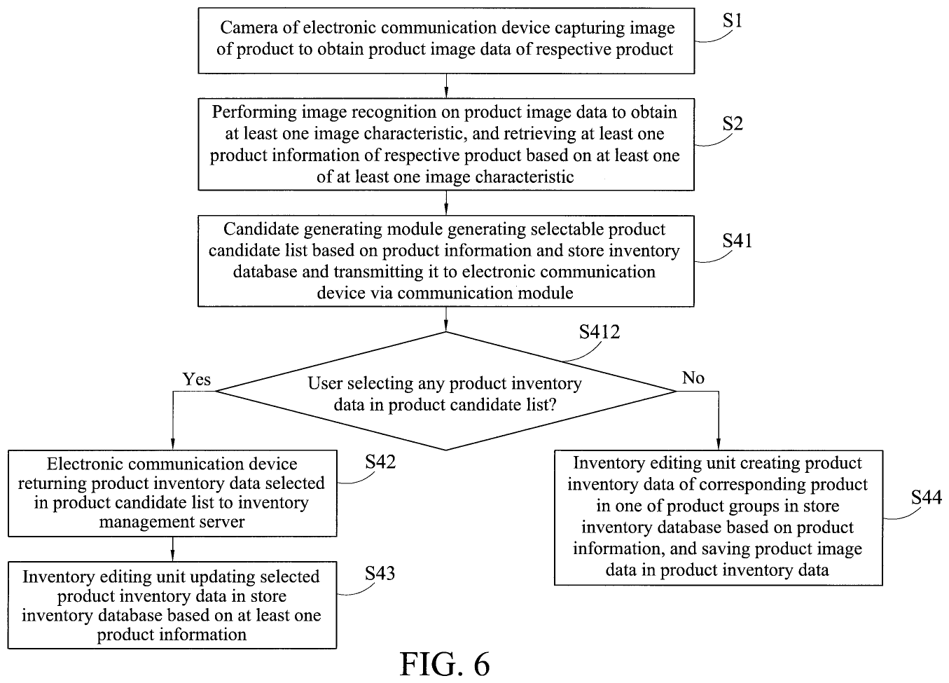

Referring to FIGS. 1 and 6, in another embodiment, after the inventory management server 2 obtains the product information corresponding to the product image information, step S41 is performed, in which the candidate generating module 25 is configured to generate a selectable product candidate list based on the product information and the store inventory database 27 and transmits it to the electronic communication device 1 via the communication module 21. The product candidate list includes at least one product inventory data entry. Once the electronic communication device 1 receives the product candidate list from the inventory management server 2, the product candidate list is displayed by the display 11 to be browsed and selected by a user.

Next, step S412 is performed to determine whether the user has selected any product inventory data in the product candidate list. When the user has selected a product inventory data of a corresponding product, step S42 is performed, in which the electronic communication device 1 returns the product inventory data selected in the product candidate list to the inventory management server 2. Once the inventory management server 2 receives the selected product inventory data, step S43 is performed, in which the inventory editing unit 222 updates the selected product inventory data in the store inventory database 27 based on the at least one product information. In other words, the at least one product information and the product image data are saved in the corresponding data fields of the product inventory data.

When the user has not selected any product inventory data in the product candidate list, step S44 is performed, where the inventory editing unit 222 creates a product inventory data of the product corresponding to the at least one product information in one of a plurality of groups of products in the store inventory database 27 based on the product information, and stores the product image data in the product inventory data. The groups of products correspond to respective product categories. The inventory editing unit selects one of the product groups based on the product information to create the product inventory data. The inventory management server 2 in this embodiment provides the product inventory data of the product or similar to the product based on the product information for selection by the user.

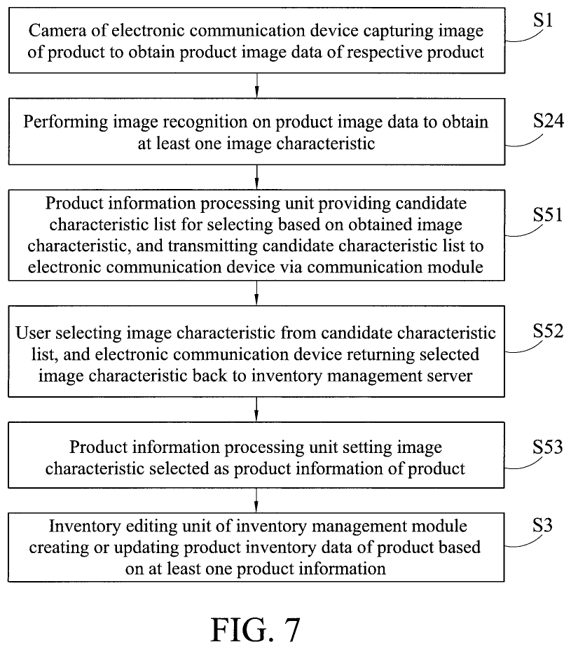

Referring to FIGS. 1 and 7, in another embodiment, after the product information processing unit 221 obtains the product image data, step S24 is performed to perform image recognition on the product image data to obtain at least one image characteristic. After the product information processing unit 221 obtains the image characteristic, step S51 is performed, in which the product information processing unit 221 provides a candidate characteristic list for selecting based on the obtained image characteristic, and transmits the candidate characteristic list to the electronic communication device 1 via the communication module 21. The candidate characteristic list comprises the at least one image characteristic. After the electronic communication device 1 receives the candidate characteristic list and displays it on the display 11, step S52 is performed, in which a user selects an image characteristic from the candidate characteristic list, and the electronic communication device 1 returns the image characteristic selected back to the inventory management server 2. After the product information processing unit 221 receives the image characteristic selected via the communication module 21, step S53 is performed, in which the product information processing unit 221 sets the image characteristic selected as the product information of the product. Thereafter, step S3 is performed, in which the inventory editing unit 222 is configured to create or update a product inventory data of the product corresponding to the at least one product information based on the product information.

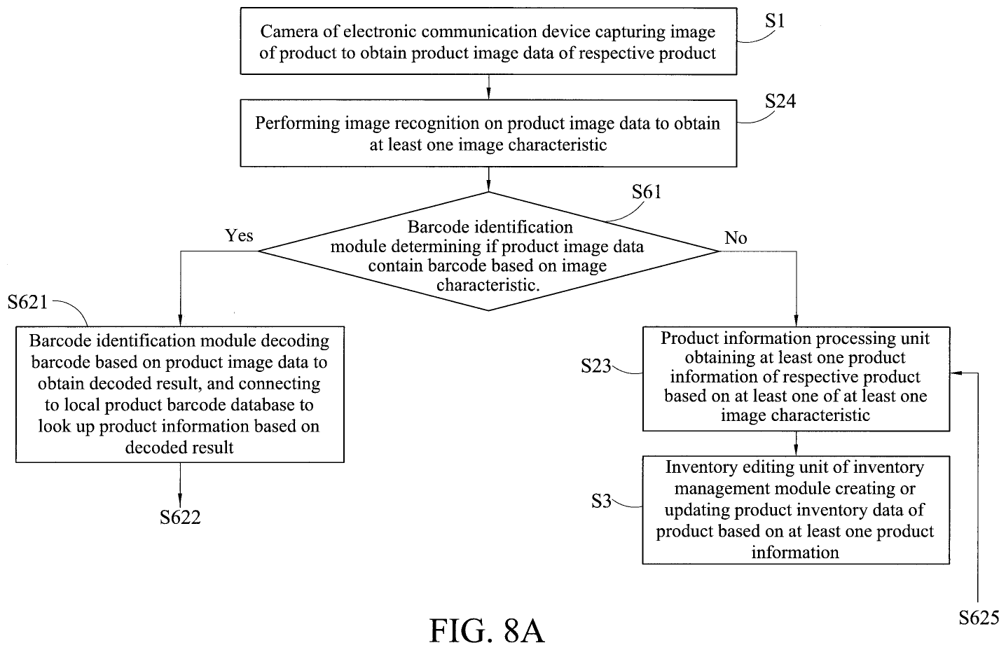

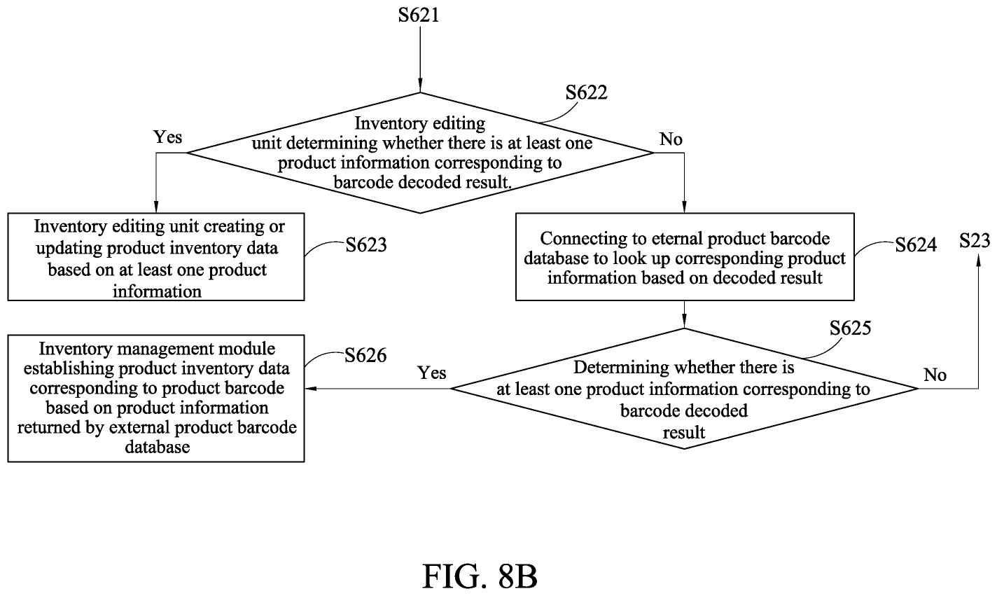

In another embodiment, referring to FIGS. 1, 8A and 8B, after the product information processing unit 221 obtains the image characteristic, step S61 is performed, in which the barcode identification module 23 is configured to determine whether the product image data contains a barcode based on the image characteristic. When it is determined that the product image data does not contain a barcode, step S23 is performed, in which at least one product information corresponding to the product is obtained based on the at least one image characteristic. Then, step S3 is performed, in which the inventory editing unit 222 is configured to create or update a product inventory data of the product corresponding to the at least one product information based on the at least one product information. In other words, in this embodiment, when the product image data includes a barcode, a product is identified by the barcode, so that a product inventory data can be created or updated.

When it is determined that the product image data includes a barcode, step S621 is performed, in which the barcode identification module 23 decodes the barcode based on the product image data, and connects to a local product barcode database 29 to look up a product information based on the decoded result. The inventory editing unit 222 connects to the local product barcode database 29 based on the barcode decoded result, and finds the corresponding product information based on the decoded result. Then, step S622 is performed, in which the inventory editing unit 222 determines whether there is at least one product information corresponding to the barcode decoded result in the local product barcode database 29. If at least one product information corresponding to the barcode decoded result exists in the local product barcode database 29, step S623 is performed, in which the inventory editing unit 222 creates or updates a product inventory data corresponding to the product barcode based on the at least one product information corresponding to the barcode decoded result. On the contrary, if at least one product information corresponding to the barcode decoded result does not exist in the local product barcode database 29, step S624 is performed to connect to an external product barcode database 4 to look up a product information corresponding to the barcode based on the barcode decoded result in the external product barcode database 4, and then step S625 is performed to determine whether there is at least one product information corresponding to the barcode decoded result. If at least one product information corresponding to the barcode decoded result exists in the external product barcode database 4, step S626 is performed, in which the inventory management module 22 establishes a product inventory data corresponding to the product barcode based on the product information returned by the external product barcode database 4. If at least one product information corresponding to the barcode decoded result does not exist in the external product barcode database 4, step S23 and S3 are repeated.

It should be noted that the local product barcode database 29 and the external product barcode database 4 store barcode information and product information of products corresponding to barcodes. Therefore, when a product has a barcode, corresponding product information can be obtained from the local product barcode database 29 and the external product barcode database 4 based on the barcode information.

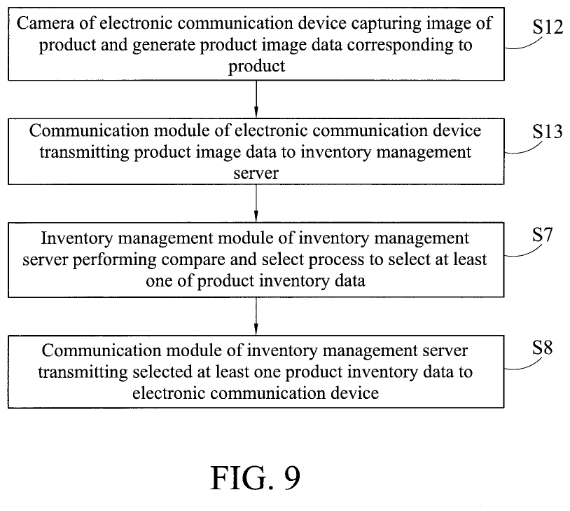

Referring to FIGS. 1 and 9, wherein FIG. 9 is a flowchart illustrating a method of querying product inventory in accordance with an embodiment of the present disclosure. The product inventory data query method is provided to allow the merchant to connect to the inventory management server 2 via the electronic communication device 1 in order to lookup product inventory data in the store inventory database 27. The steps of the product inventory data query method are described below. First, step S12 is performed, in which the camera 12 of the electronic communication device 1 captures the image of a product to be queried, and generates product image data corresponding to the queried product. Then, step S13 is performed, in which the communication module 14 of the electronic communication device 1 transmits the product image data to the inventory management server 2.

After the communication module 21 of the inventory management server 2 receives the product image data, step S7 is performed, wherein the inventory management module 22 of the inventory management server 2 is configured to perform a compare and select process. The compare and select process compares the product image data received from the electronic communication device with several product inventory data entries in the at least one store inventory database 27 and select at least one of the product inventory data from the at least one store inventory database. Then, step S8 is performed, in which the communication module 21 of the inventory management server 2 further transmits the selected at least one product inventory data to the electronic communication device 1.

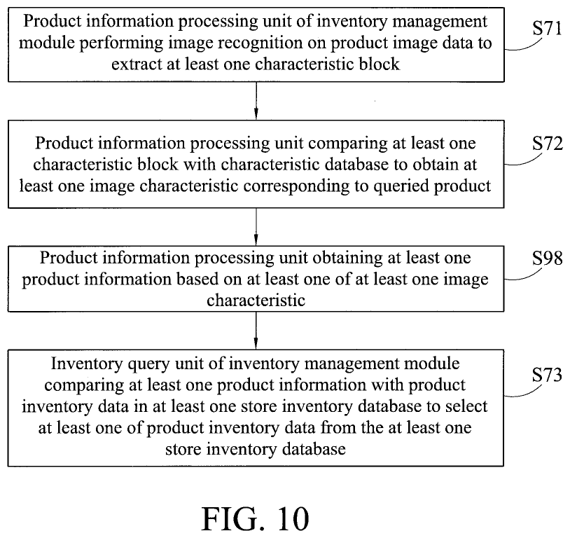

Referring to FIGS. 1, 9 and 10, wherein FIG. 10 is a flowchart illustrating another embodiment of the compare and select process described in step S7. Steps of the compare and select process in this embodiment are described as follows. First, step S71 is performed, in which the product information processing unit 221 of the inventory management module 22 is configured to perform image recognition on the product image data to extract at least one characteristic block. After the at least one characteristic block is obtained, step S72 is performed, in which the product information processing unit 221 is configured to compare the at least one characteristic block with the characteristic database 26 to obtain at least one image characteristic corresponding to the queried product. Then, step S98 is performed, in which the product information processing unit 221 is configured to obtain at least one product information based on at least one of the at least one image characteristic. Then, step S73 is performed, in which the inventory query unit 223 of the inventory management module 22 is configured to compare the at least one product information with those product inventory data in the at least one store inventory database 27 to select at least one of those product inventory data from the at least one store inventory database.

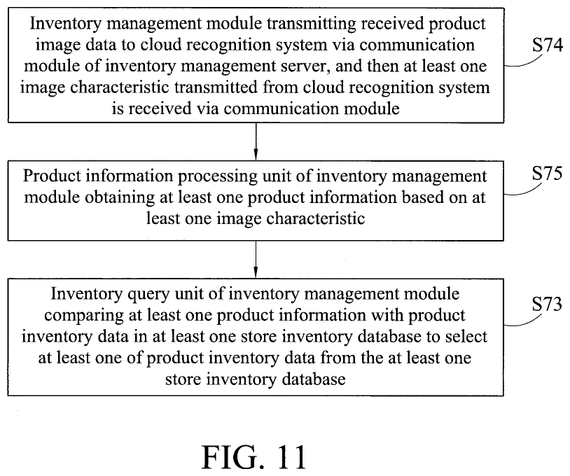

Referring to FIGS. 1, 9 and 11, wherein FIG. 11 is a flowchart illustrating another embodiment of the compare and select process described in step S7. Steps of the compare and select process in this embodiment are described as follows. First, step S74 is performed, in which the inventory management module 22 is configured to transmit the received product image data to the cloud recognition system 3 via the communication module 21 of the inventory management server 2, and then at least one image characteristic transmitted from the cloud recognition system 3 is received via the communication module 21 of the inventory management server 2. Then, step S75 is performed, in which the product information processing unit 221 of the inventory management module 22 is configured to obtain at least one product information based on the at least one image characteristic. After product information is obtained, step S73 is performed, in which the inventory query unit 223 of the inventory management module 22 is configured to compare the at least one product information with those product inventory data in the at least one store inventory database 27 to select at least one of the product inventory data from the at least one store inventory database. The cloud recognition system 3 in this embodiment performs image recognition based on the received product image data, and returns the recognition result back to the inventory management server 2. The cloud recognition system 3 can be a cloud recognition system with machine learning models and Internet image searching capability, for example, Google Cloud Vision, Microsoft Computer Vision, etc. An application programming interface (API) can be connected with the cloud recognition system to assist in image recognition and analysis.

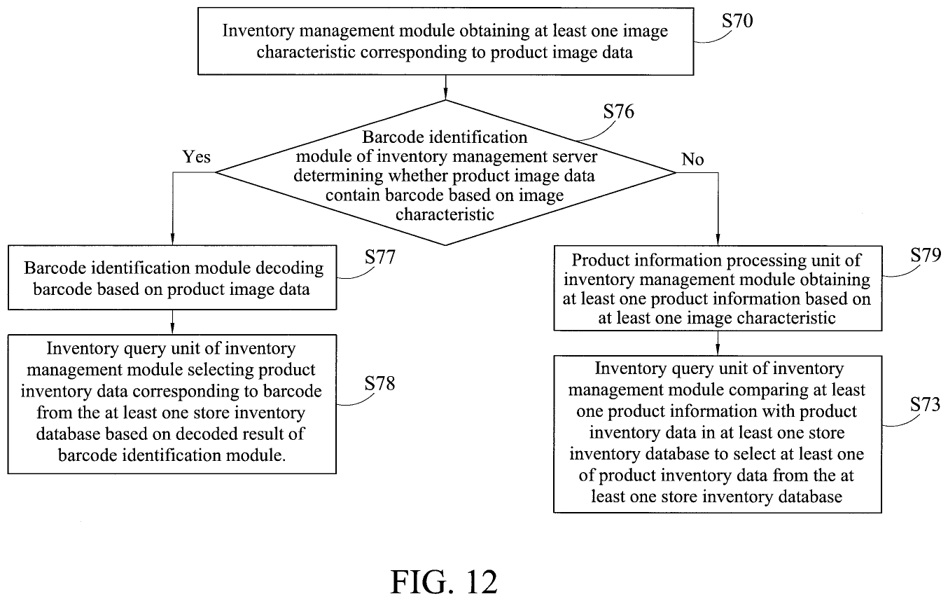

Referring to FIGS. 1, 9 and 12, wherein FIG. 12 is a flowchart illustrating another embodiment of the compare and select process described in step S7. Steps of the compare and select process in this embodiment are described as follows. First, step S70 is performed, in which the inventory management module 22 obtains at least one image characteristic corresponding to the product image data. After the inventory management server 2 obtains the image characteristic corresponding to the product image data, step S76 is performed, in which the barcode identification module 23 of the inventory management server 2 is configured to determine whether the product image data contains a barcode based on the image characteristic. When the product image data contains a barcode, step S77 is performed, in which the barcode identification module 23 performs barcode decoding based on the product image data. After decoding, step S78 is performed, in which the inventory query unit 223 of the inventory management module 22 selects a product inventory data corresponding to the barcode from the at least one store inventory database 27 based on the decoded result of the barcode identification module 23.

On the contrary, when it is determined that the product image data contains no barcode, step S79 is performed, in which the product information processing unit 221 of the inventory management module 22 is configured to obtain at least one product information based on the at least one image characteristic. After the product information is obtained, step S73 is performed, in which the inventory query unit 223 of the inventory management module 22 is configured to compare the at least one product information with those product inventory data in the at least one store inventory database 27 to select at least one of the product inventory data from the at least one store inventory database. It should be noted that the means for obtaining an image characteristic in step S70 of this embodiment may be similar to those described in step S71 of the embodiment described in connection with FIG. 10 or step S74 of the embodiment described in connection with FIG. 11.

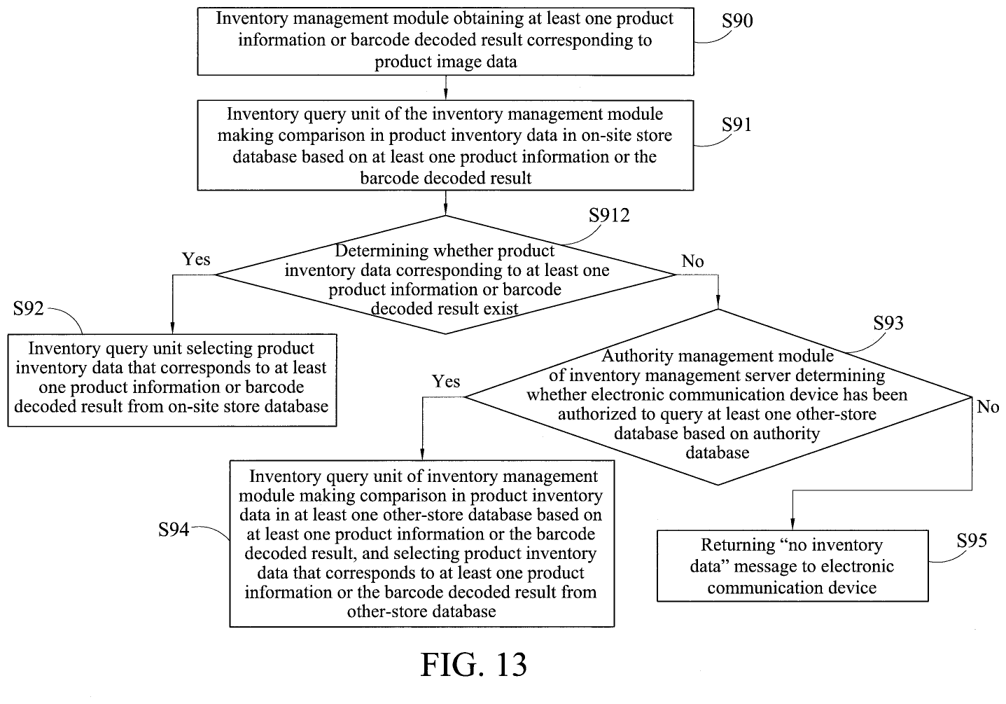

Referring to FIGS. 1, 9 and 13, wherein FIG. 13 is a flowchart illustrating another embodiment of the compare and select process described in step S7. Steps of the compare and select process in this embodiment are described as follows. After the inventory management module 22 has obtained the at least one product information or the decoded result of the barcode identification module 23, step S91 is performed, in which the inventory query unit 223 of the inventory management module 22 is configured to make a comparison in the product inventory data in the on-site store database 271 based on the at least one product information or the decoded result of the barcode identification module 23, and step S912 is performed to determine whether a product inventory data corresponding to the at least one product information or the decoded result of the barcode identification module 23 exists. The on-site store database 271 stores inventory data of a merchant to which the electronic communication device 1 corresponds, while the other-store database 272 stores inventory data of other merchants.

When a product inventory data corresponding to the at least one product information or the decoded result of the barcode identification module 23 exists in the on-site store database 271, step S92 is performed, in which the inventory query unit 223 is configured to select the product inventory data that corresponds to the at least one product information or the decoded result of the barcode identification module 23 from the on-site store database 271. On the contrary, if a product inventory data corresponding to the at least one product information or the decoded result of the barcode identification module 23 does not exist in the on-site store database 271, step S93 is performed, in which the authority management module 24 of the inventory management server 2 is configured to determine whether the electronic communication device 1 has been authorized to query at least one other-store database 272 based on an authority database 28. When the authority management module 24 determines that the electronic communication device 1 is authorized to query the at least one other-store database 272, step S94 is performed, in which the inventory query unit 223 of the inventory management module 22 is configured to make a comparison in product inventory data in the at least one other-store database 272 based on the at least one product information or the decoded result of the barcode identification module 23, and selects a product inventory data that corresponds to the at least one product information or the decoded result of the barcode identification module 23 from the other-store database 272. When the authority management module 24 determines that the electronic communication device 1 is not authorized to query the at least one other-store database 272, step S95 is performed to return a “no inventory data” message to the electronic communication device 1. In other embodiments, a “no authority to query other stores” message can also be returned back to the electronic communication device 1.

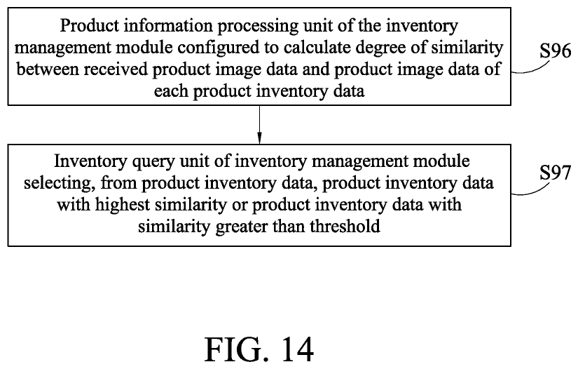

Referring to FIGS. 1, 9 and 14, wherein FIG. 14 is a flowchart illustrating another embodiment of the compare and select process described in step S7. Steps of the compare and select process in this embodiment are described as follows. First, step S96 is performed, in which the product information processing unit 221 of the inventory management module 22 is configured to calculate a degree of similarity between the received product image data and the product image data of each product inventory data. Next, step S97 is performed, in which the inventory query unit 223 of the inventory management module 22 selects, from the product inventory data, a product inventory data with the highest similarity or a product inventory data with a similarity greater than a threshold.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A method of managing product inventory data, using at least one electronic communication device and a server communicatively connected with the at least one electronic communication device, wherein each of the at least one electronic communication device comprises a camera, the method comprising:
capturing, by the camera, an image of a product to obtain product image data;
performing image recognition on the product image data to obtain at least one image characteristic and retrieving at least one product information of the product based on at least one of the at least one image characteristic; and
creating or updating a product inventory data for the product in the server based on the at least one product information.

2. The method of claim 1, wherein performing image recognition on the product image data to obtain at least one image characteristic and retrieving at least one product information of the product based on at least one of the at least one image characteristic comprises:
performing image recognition on the product image data to obtain at least one image characteristic; and
generating a candidate characteristic list for selecting,
wherein the candidate characteristic list comprises the at least one image characteristic, and the image characteristic selected is set as the product information of the product.

3. The method of claim 1, wherein performing image recognition on the product image data to obtain the at least one image characteristic and retrieving the at least one product information of the product based on at least one of the at least one image characteristic comprises:
performing image recognition on the product image data to extract at least one characteristic block;
comparing the at least one characteristic block with a characteristic database to obtain the at least one image characteristic corresponding to the product; and
obtaining the at least one product information based on at least one of the at least one image characteristic.

4. The method of claim 1, wherein performing image recognition on the product image data to obtain the at least one image characteristic and retrieving the at least one product information of the product based on the at least one of the at least one image characteristic comprises:
transmitting the product image data to a cloud recognition system; and
receiving the at least one image characteristic transmitted by the cloud recognition system, and retrieving the at least one product information of the product based on at least one of the at least one image characteristic.

5. The method of claim 1, further comprising:
determining whether the product image data contains a barcode based on the at least one image characteristic;
when it is determined that the product image data contains a barcode, decoding the barcode based on the product image data, and creating or updating the product inventory data corresponding to the barcode of the product in the server based on a barcode decoded result; and
when it is determined that the product image data contains no barcode, creating or updating the product inventory data of the product corresponding to the at least one product information in the server based on the at least one product information.

6. The method of claim 5, wherein decoding the barcode based on the product image data, and creating or updating the product inventory data of corresponding to the barcode of the product in the server based on a decoded result when it is determined that the product image data contains a barcode comprises:
decoding the barcode based on the product image data to obtain a barcode decoded result, and connecting to a local product barcode database to determine whether at least one product information that corresponds to the decoded result exists;
when the at least one product information that corresponds to the barcode decoded result exists in the local product barcode database, creating or updating the product inventory data corresponding to the barcode of the product based on the at least one product information; and
when the at least one product information that corresponds to the barcode decoded result does not exist, connecting to an external product barcode database to look up a product information corresponding to the barcode based on the barcode decoded result, wherein after the external product barcode database returns the at least one product information corresponding to the barcode decoded result, creating or updating a product inventory data corresponding to the barcode of the product based on the at least one product information returned by the external product barcode database.

7. The method of claim 1, further comprising:
generating a selectable product candidate list based on the at least one product information and an inventory database of the server, the product candidate list including at least one product inventory data,
when one of the product inventory data in the product candidate list is selected, updating the product inventory data selected in the inventory database based on the at least one product information, and
when none of the product inventory data in the product candidate list is selected, creating the product inventory data corresponding to the product in the inventory database based on the at least one product information.

8. The method of claim 7, wherein the inventory database includes a plurality of groups of products corresponding to a plurality of product categories, and when none of the product inventory data in the product candidate list is selected, selecting one of the product groups based on the at least one product information, and creating the product inventory data corresponding to the product in the product group selected.

9. The method of claim 7, further comprising receiving the product candidate list from the server.

10. The method of claim 1, wherein each of the product inventory data comprises a plurality of data fields, and creating or updating a product inventory data for the product in the server based on the at least one product information comprises:
saving the at least one product information and the product image data in the corresponding data fields of the product inventory data.

11. An inventory management server, communicatively connected with at least one electronic communication device, wherein each of the at least one electronic communication device comprises a camera configured for obtaining product image data of a product, the inventory management server comprising:
a communication module, configured to exchange data with the at least one electronic communication device and receive the product image data; and
an inventory management module, comprising a product information processing unit and an inventory editing unit configured to communicate with the product information processing unit, wherein the product information processing unit is configured to obtain at least one image characteristic based on the product image data and obtain at least one product information of the product based on the at least one image characteristic,
wherein the inventory editing unit is configured to create or update a product inventory data of the product based on the at least one product information.

12. The inventory management server of claim 11, wherein the product information processing unit is further configured to:
perform image recognition on the product image data to obtain the at least one image characteristic;
generate a candidate characteristic list, and transmit the candidate characteristic list via the communication module, wherein the candidate characteristic list comprises the at least one image characteristic; and
receive at least one of the at least one image characteristic selected from the candidate characteristic list via the communication module, and set the image characteristic selected from the candidate characteristic list as a product information of the product.

13. The inventory management server of claim 11, wherein the product information processing unit is further configured to:
perform image recognition on the product image data to extract at least one characteristic block;
compare the at least one characteristic block with a characteristic database to obtain the at least one image characteristic corresponding to the product; and
obtain at least one product information of the product based on at least one of the at least one image characteristic.

14. The inventory management server of claim 11, wherein the product information processing unit is further configured to:
transmit the product image data via the communication module to a cloud recognition system and obtain the at least one image characteristic transmitted by the cloud recognition system via the communication module, and
retrieve the at least one product information of the product based on the at least one image characteristic.

15. The inventory management server of claim 11, further comprising:
a barcode identification module, configured to communicate with the product information processing unit and determine whether the product image data contains a barcode based on the at least one image characteristic,
when it is determined that the product image data contains a barcode, the barcode identification module decodes the barcode based on the product image data, and the inventory editing unit creates or updates the product inventory data corresponding to the barcode of the product based on a barcode decoded result,
when it is determined that the product image data contains no barcode, the inventory editing unit creates or updates the product inventory data of the product based on the at least one product information.

16. The inventory management server of claim 15, further comprising a local product barcode database, and when it is determined that the product image data contains a barcode, the barcode identification module decodes the barcode based on the product image data to obtain a barcode decoded result, and connects to the local product barcode database to determine whether at least one product information that corresponds to the barcode decoded result exists, and when at least one product information that corresponds to the barcode decoded result exists in the local product barcode database, the inventory editing unit creates or updates the product inventory data corresponding to the barcode of the product based on the at least one product information.

17. The inventory management server of claim 11, further comprising an inventory database and a candidate generating module communicating with the product information processing unit, wherein the candidate generating module is configured to generate a selectable product candidate list based on the at least one product information and the inventory database, the product candidate list comprising at least one product inventory data,
when one of the product inventory data in the product candidate list is selected, the inventory editing unit updates the selected product inventory data in the inventory database based on the at least one product information,
when none of the product inventory data in the product candidate list is selected, the inventory editing unit creates the product inventory data corresponding to the product in the inventory database based on the at least one product information.

18. The inventory management server of claim 17, wherein the inventory database comprises a plurality of groups of products corresponding to a plurality of product categories, and when none of the product inventory data in the product candidate list is selected, the inventory editing unit selects one of the product groups based on the at least one product information, and creates the product inventory data corresponding to the product in the selected product group.

19. The inventory management server of claim 17, wherein the communication module transmits the product candidate list to the at least one electronic communication device.

20. The inventory management server of claim 11, wherein each of the product inventory data comprises a plurality of data fields, and the inventory editing unit saves the at least one product information and the product image data in the corresponding data fields of the product inventory data.

21. A method of querying product inventory, using at least one electronic communication device and a server communicatively connected with the at least one electronic communication device, wherein each of the at least one electronic communication device comprises a camera and the server comprises at least one store inventory database, the method comprising:
capturing, by the camera, an image of a product to obtain product image data;
receiving, by the server, the product image data from the electronic communication device;
comparing the product image data received from the electronic communication device with a plurality of product inventory data in the at least one store inventory database to select at least one of the plurality of product inventory data from the at least one store inventory database; and
transmitting the product inventory data selected from the at least one store inventory database to the electronic communication device.

22. The method of claim 21, wherein comparing the product image data received from the electronic communication device with a plurality of product inventory data in the at least one store inventory database to select at least one of the plurality of product inventory data comprises:
performing image recognition on the product image data to extract at least one characteristic block;
comparing the at least one characteristic block with a characteristic database to obtain at least one image characteristic corresponding to the product;
obtaining at least one product information of the product based on at least one of the at least one image characteristic; and
comparing the at least one product information with the product inventory data in the at least one store inventory database to select at least one of the product inventory data from the at least one store inventory database.

23. The method of claim 21, wherein comparing the product image data received from the electronic communication device with a plurality of product inventory data in the at least one store inventory database to select at least one of the plurality of product inventory data comprises:
transmitting the product image data to a cloud recognition system;
receiving at least one image characteristic from the cloud recognition system; and
obtaining at least one product information based on the at least one image characteristic, and comparing the at least one product information with the product inventory data in the at least one store inventory database to select at least one of the product inventory data from the at least one store inventory database.

24. The method of claim 22, wherein the at least one store inventory database comprises an on-site store database corresponding to the electronic communication device and at least one other-store database not corresponding to the electronic communication device, and comparing the at least one product information with the product inventory data in the at least one store inventory database to select at least one of the product inventory data comprises:
making a comparison in the product inventory data in the on-site store database based on the at least one product information to determine whether a product inventory data corresponding to the at least one product information exists,
when a product inventory data corresponding to the at least one product information exists in the on-site store database, selecting the product inventory data corresponding to the at least one product information from the on-site store database,
when no product inventory data corresponding to the at least one product information exists in the on-site store database, making a comparison in the product inventory data in the other-store database based on the at least one product information to determine whether a product inventory data corresponding to the at least one product information exists, and
when a product inventory data corresponding to the at least one product information exists in the other-store database, selecting the product inventory data corresponding to the at least one product information from the other-store database.

25. The method of claim 24, wherein making a comparison in the product inventory data in the other-store database based on the at least one product information to determine whether a product inventory data corresponding to the at least one product information exists comprises:
determining whether the electronic communication device has been authorized to query at least one other-store database based on an authority database of the server, and
when the electronic communication device is authorized to query the at least one other-store database, making a comparison in the product inventory data in the other-store database based on the at least one product information to determine whether a product inventory data corresponding to the at least one product information exists.

26. The method of claim 21, further comprising:
determining whether the product image data contains a barcode,
when it is determined that the product image data contains a barcode, decoding the barcode based on the product image data and selecting the product inventory data corresponding to the barcode from the product inventory database.

27. The method of claim 21, wherein comparing the product image data received from the electronic communication device with a plurality of product inventory data in the at least one store inventory database to select at least one of the plurality of product inventory data comprises:
calculating a degree of similarity between the product image data received from the electronic communication device and the product image data of each product inventory data; and
selecting, from these product inventory data, a product inventory data with the highest degree of similarity or a product inventory data with a degree of similarity greater than a threshold.

28. An inventory management server, communicatively connecting with at least one electronic communication device, wherein each electronic communication device comprises a camera configured for capturing an image of a product to obtain product image data, the inventory management server comprising:
a communication module, configured to exchange data with the at least one electronic communication device and receive the product image data; and
an inventory management module, configured to compare the product image data received from the electronic communication device with a plurality of product inventory data to select at least one of the plurality of product inventory data,
wherein the communication module is further configured to transmit the at least one product inventory data selected from the at least one store inventory database to the electronic communication device.

29. The inventory management server of claim 28, wherein the inventory management module is further configured to:
perform image recognition on the product image data to extract at least one characteristic block;
compare the at least one characteristic block with a characteristic database to obtain at least one image characteristic corresponding to the product;
obtain at least one product information of the product based on at least one of the at least one image characteristic; and
compare the at least one product information with the product inventory data in the at least one store inventory database to select at least one of the product inventory data from the at least one store inventory database.

30. The inventory management server of claim 28, wherein the inventory management module is further configured to:
transmit the product image data to a cloud recognition system via the communication module;
receive at least one image characteristic from the cloud recognition system via the communication module; and
obtain at least one product information based on the at least one image characteristic, and compare the at least one product information with the product inventory data in the at least one store inventory database to select at least one of the product inventory data from the at least one store inventory database.

31. The inventory management server of claim 29, wherein the at least one store inventory database includes an on-site store database corresponding to the electronic communication device and at least one other-store database not corresponding to the electronic communication device, and the inventory management module is further configured to:
make a comparison in the product inventory data in the on-site store database based on the at least one product information to determine whether a product inventory data corresponding to the at least one product information exists,
when a product inventory data corresponding to the at least one product information exists in the on-site store database, selecting the product inventory data corresponding to the at least one product information from the on-site store database,
when no product inventory data corresponding to the at least one product information exists in the on-site store database, making a comparison in the product inventory data in the other-store database based on the at least one product information to determine whether a product inventory data corresponding to the at least one product information exists, and
when a product inventory data corresponding to the at least one product information exists in the other-store database, selecting the product inventory data corresponding to the at least one product information from the other-store database.

32. The inventory management server of claim 31, further comprising:
an authority management module, configured to determine whether the electronic communication device has been authorized to query the at least one other-store database based on an authority database,
when the authority management module determines that the electronic communication device is authorized to query the at least one other-store database, the inventory management module makes a comparison in the product inventory data in the at least one other-store database based on the at least one product information to determine whether a product inventory data corresponding to the at least one product information exists.

33. The inventory management server of claim 28, further comprising:
a barcode identification module, configured to determine whether the product image data contains a barcode, and decode the barcode based on the product image data when it is determined that the product image data contains a barcode,
wherein the inventory management module is configured to select a product inventory data corresponding to the barcode from the at least one store inventory database.

34. The inventory management server of claim 28, wherein the inventory management module is further configured to:
calculate a degree of similarity between the product image data received from the electronic communication device and the product image data of each product inventory data; and
select, from the product inventory data, a product inventory data with the highest degree of similarity or a product inventory data with a degree of similarity greater than a threshold.
